(19) United States
(12) Patent Application Publication
(10) Pub. No.: US 2015/0192088 A1
(43) Pub. Date: Jul. 9, 2015

(54) CYLINDER HEAD ASSEMBLY

(71) Applicants: Perusahaan Otomobil Nasional Sdn Bhd, Subang Jaya, Selangor Darul Ehsan (MY); Ricardo UK Limited, Shoreham-By-Sea,West Sussex (GB)

(72) Inventors: Mohd Suffian Sahadan, Kuala Lumpur (MY); Gordon Taylor, Shoreham-By-Sea (GB)

(73) Assignee: Perusahaan Otomobil Nasional Sdn Bhd, Subang Jaya, Selangor Darul Ehsan (MY)

(21) Appl. No.: 14/409,106

(22) PCT Filed: Jun. 18, 2013
(86) PCT No.: PCT/MY2013/000111

§ 371 Date: Dec. 18, 2014

(30) Foreign Application Priority Data
Jun. 18, 2012 (MY) PI 2012002751

(51) Int. Cl. F02F 1/24; F02F 1/36; F02B 17/00

(52) U.S. Cl. CPC F02F 1/242; F02B 17/005; F02F 1/36

(57) ABSTRACT

A cylinder head assembly for an internal combustion engine including a cylinder head, a water jacket mountable to said cylinder head, and a fuel injector and a spark plug mountable in the water jacket so as to extend through the cylinder head and into a corresponding combustion chamber. The spark plug and fuel injector are mountable along either a first or second axis, and the cylinder head has an injector recess shaped to receive the spark plug and the injector along both first and second axes.

### REFERENCE TO RELATED APPLICATIONS

This application is a United States National Phase application of PCT Application No. PCT/MY2013/000111 filed on Jun. 18, 2013, which claims priority to Malaysian Application No. PI 2012002751 filed on Jun. 18, 2012.

### FIELD OF THE INVENTION

The invention relates to internal combustion engines and, in particular, spray guided direct injection (SGDI) systems for the direct injection of fuel into the combustion chamber of such engines. Specifically, the invention relates to the arrangement of a cylinder head assembly of said internal combustion engine (ICE).

### BACKGROUND

Spray guided direct injection systems for internal combustion engines provide a lean stratified combustion which has the dual advantage of reducing emissions as well as improving fuel efficiency. SGDI systems are characterized by having a centrally mounted direct injector with the spark plug mounted in close proximity to the injector.

In order to achieve this close proximity, the injector and spark plug are often packaged together and located at the top of the cylinder head so as to be intermediate of the valves. This packaging results in the spark plug and injector being aligned so as to define a longitudinal plane that is parallel to the line of crankshaft axis within the engine or a transverse plane that is orthogonal to the line of crankshaft axis within the engine.

Whether the package is longitudinal or transverse depends upon the application being considered with both having advantages. To have the package transverse to the crankshaft axis line is more suitable for high volume mass produced engines with low to medium power output due to the fact that the assembly of spark plugs, fuel injectors and tool access are simple and straight forward.

A longitudinal arrangement is more easily cooled and so is more suitable to provide for more specialized, high performance vehicles, which consequently generate higher engine temperatures. Accordingly whilst there is less accessibility between the spark plug/injector packages of adjacent cylinders, the longitudinal arrangement tends to be used for vehicles where high performance is required where more efficient cooling becomes important.

The difficulty comes in with the cost of customization in that whilst consumers may seek a high performance, low emission vehicle, the degree to which they are prepared to pay a premium for an entirely new engine is limited.

### SUMMARY OF INVENTION

In a first aspect the invention provides a cylinder head assembly for an internal combustion engine including a cylinder head, a water jacket mountable to the cylinder head, and a fuel injector and spark plug mountable in the water jacket so as to extend through the cylinder head and into a corresponding combustion chamber. The spark plug and fuel injector are mountable along either a first or second axis, and the cylinder head has an injector recess shaped to receive the spark plug and injector along both first and second axes.

Accordingly, by providing a cylinder head that can receive spark plug/injector packages in alignment along first and second axes, for instance along both a longitudinal and transverse arrangement, the cost of manufacture is reduced through the use of a common cylinder head main casting for both applications. It follows that the cost of customization may therefore be reduced. It follows that, for one embodiment, only the cooling water jacket may be a customized component.

In a further embodiment, customization of the water jacket may include a water jacket for a longitudinal package arrangement having larger channels and voids so as to more efficiently distribute cooling fluid, which may in turn accommodate higher heat generation for high performance vehicles.

### BRIEF DESCRIPTION OF DRAWINGS

It will be convenient to further describe the present invention with respect to the accompanying drawings that illustrate possible arrangements of the invention. Other arrangements of the invention are possible and consequently, the particularity of the accompanying drawings is not to be understood as superseding the generality of the preceding description of the invention.

FIG. 1 is an isometric view of a cylinder head according to one embodiment of the present invention;

FIG. 2A is an exploded isometric view of a cylinder head assembly according to one embodiment of the present invention; and

FIG. 2B is an exploded isometric view of a cylinder head assembly according to a further embodiment of the present invention.

### DETAILED DESCRIPTION

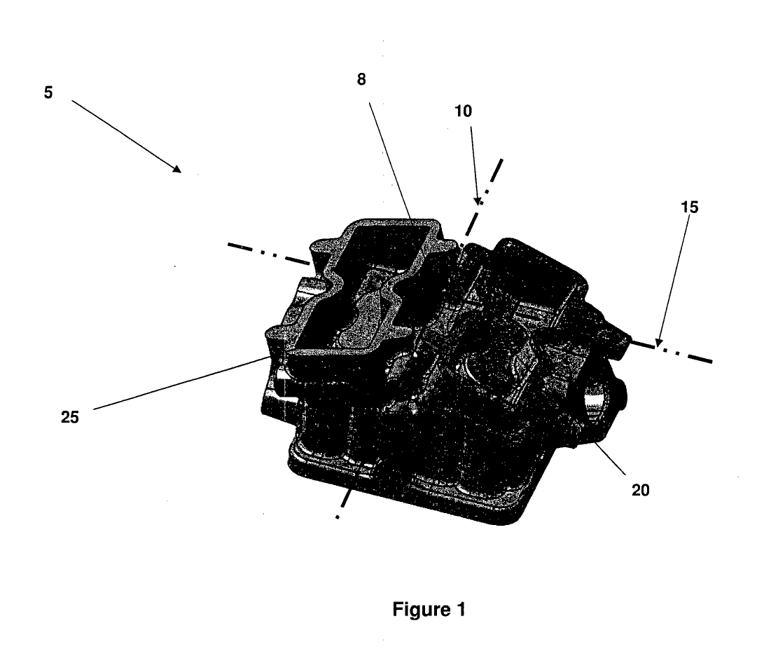

FIG. 1 shows a cylinder head casting 5 according to one embodiment of the present invention. The cylinder head 5 includes recesses 20, 25 for placement of valves (not shown) for operation in the combustion chamber (not shown). The cylinder head 5 has been manufactured so as to be used with a SGDI system and so includes an injector recess 8 for receiving a package of a fuel injector and a spark plug (not shown). The advantage provided by the cylinder head 5 according to the present invention is the ability to receive a spark plug/injector package which is either aligned along a first axis, such as along a longitudinal axis 10 parallel to the crankshaft axis within an engine or a spark plug/injector package aligned along a second axis, such as an axis 15 transverse to the crankshaft axis within an engine.

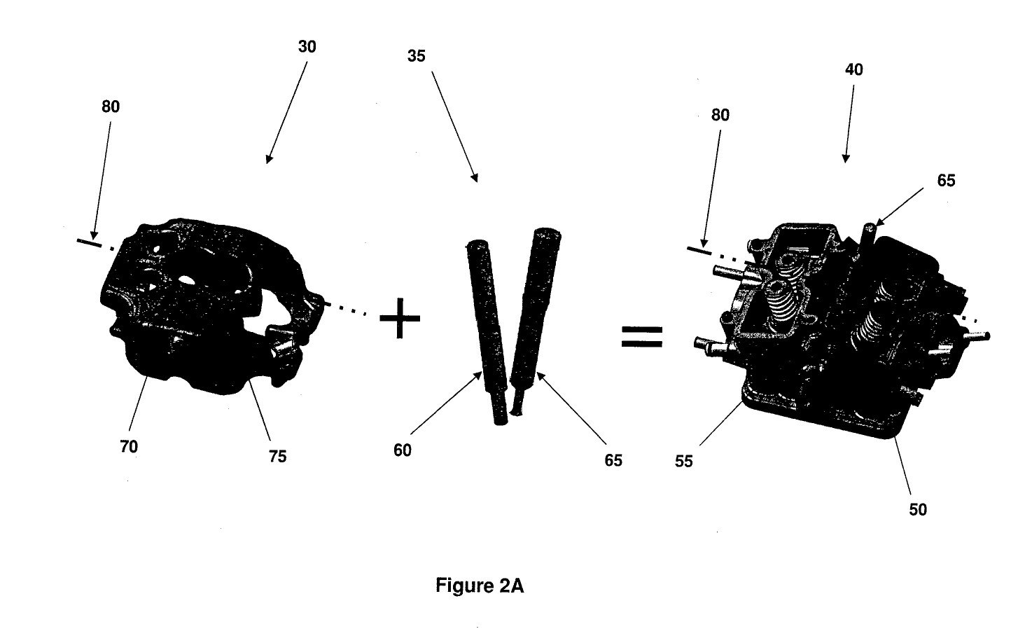

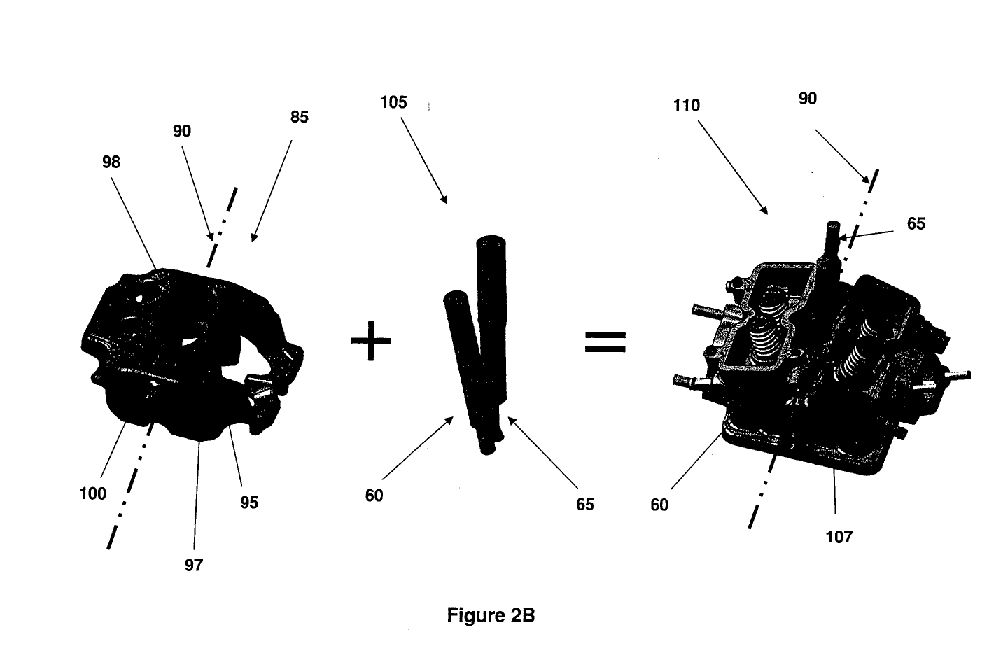

Accordingly, the cylinder head 5 is arranged to be suitable main stream applications, suitable for a transverse injector package, or customized applications, suitable for a longitudinal package. FIG. 2A shows the transverse arrangement for the cylinder head assembly according to one embodiment of the present invention. Here, a purposed-built water jacket 30 includes recesses 70, 75 for receiving a spark plug/injector package 35 arranged to align transversely along an axis 80. The cylinder head assembly 40 is shown in the transverse configuration, with the water jacket non visible since it is an internal core. In this configuration, the injector 65 is inserted in the transverse portion 50 of the injector recess 55 and so aligned along the transverse axis 80. The spark plug 60 has been omitted for clarity. This particular arrangement corresponds to a main stream application where parts and tools accessibility is paramount in achieving efficiency of mass production.

FIG. 2B shows an alternative of arrangement whereby a purpose-built water jacket 85 is arranged to receive the spark plug/injector package 105 along a longitudinal axis 90. The water jacket 85 includes recesses 95, 100 corresponding to the spark plug 60 and injector 65. FIG. 2B further shows the cylinder head assembly 110, with the water jacket 85 omitted, having the spark plug 60 and injector 65 aligned along the axis 90.

The longitudinal arrangement of FIG. 2B allows the water jacket 85 to have enlarged portions 97, 98 on either side of the recesses 95, 100 which provide greater flow passed the spark plug and injector when assembled. This arrangement allows for more efficient cooling within the water jacket. It follows that this will permit the customized cylinder head assembly 1 10 to operate at high temperatures and so provide greater power output.

Accordingly, the cylinder head according to the present invention is capable of both main stream production as well as customization, leading to a reduction in manufacturing costs and reduced inventory.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

1. A cylinder head assembly for an internal combustion engine, the assembly comprising:
a cylinder head;
a water jacket mountable to said cylinder head; and
a fuel injector and a spark plug mountable in said water jacket so as to extend through the cylinder head and into a corresponding combustion chamber, wherein said spark plug and fuel injector are mountable along either a first or second axis, said cylinder head having an injector recess shaped to receive the spark plug and said injector along both first and second axes.

2. The assembly according to claim 1, wherein the first axis is a longitudinal axis parallel to a crankshaft axis of the engine, and the second axis is a transverse axis orthogonal to the crankshaft axis of the engine.

3. The assembly according to claim 1, wherein the water jacket includes recesses to receive the spark plug and said fuel injector arranged along the first axis.

4. The assembly according to claim 1, wherein the water jacket includes recesses to receive the spark plug and said fuel injector arranged along the second axis.

5. The assembly according to claim 1, wherein the cylinder head includes two valve recesses corresponding to inlet and outlet valves for said combustion chamber, said injector recess positioned intermediate said valve recesses.

6. A cylinder head for a cylinder head assembly comprising:
a water jacket mountable to said cylinder head; and
a fuel injector and a spark plug mountable in said water jacket so as to extend through the cylinder head and into a corresponding combustion chamber, wherein said spark plug and the fuel injector are mountable along either a first or second axis, said cylinder head having an injector recess shaped to receive the spark plug and injector along both first and second axes.
